(19) United States
(12) Patent Application Publication
(10) Pub. No.: US 2026/0328016 A1
(43) Pub. Date: Oct. 22, 2026

(54) VEHICLE-MOUNTED FOLDING TERRACE AND VEHICLE THEREOF

(71) Applicant: Anhui Wollin International Co., Ltd., Wuhu (CN)

(72) Inventors: Jinsong Ye, Wuhu (CN); Quanfu Liu, Wuhu (CN); Han Xu, Wuhu (CN)

(21) Appl. No.: 19/106,817

(22) PCT Filed: Sep. 21, 2022
(86) PCT No.: PCT/CN2022/120337

§ 371 Date: Feb. 26, 2025

(30) Foreign Application Priority Data
Aug. 26, 2022 (CN) 202211037811.X

(51) Int. Cl. E04H 15/06; E04H 15/00

(52) U.S. Cl. CPC E04H 15/06; E04H 15/008

(57) ABSTRACT

A vehicle-mounted folding terrace is provided which includes a telescopic sliding mechanism, a folding terrace body structure, and a supporting mechanism. The folding terrace body structure includes a base connected to the telescopic sliding mechanism and which can slide in the sliding mechanism in a far-end direction and extend out of the sliding mechanism. The folding terrace body structure can be folded and unfolded in a sliding direction of the telescopic sliding mechanism and/or in an upward direction of the base. The supporting mechanism is connected to the bottom of a sliding extension end of the folding terrace body structure and is configured to support the vehicle-mounted folding terrace and at least partially define an entrance and exit of the vehicle-mounted folding terrace. The vehicle-mounted folding terrace has a simple structure, is convenient and flexible to mount, has high transverse space expansibility, and occupies a small space after being folded.

### TECHNICAL FIELD

The present invention belongs to the technical field of vehicle-mounted folding terraces, and in particular relates to a vehicle-mounted folding terrace, and a vehicle having the vehicle-mounted folding terrace.

### BACKGROUND

With the gradual development of the automobile manufacturing industry, the types of vehicles and vehicle accessories have increased, and corresponding requirements have become higher. Furthermore, various vehicle-mounted folding terrace products have emerged one after another. However, existing vehicle-mounted folding terraces generally can only be installed on a roof of a vehicle or inside a vehicle body. When a vehicle-mounted folding terrace is installed on a roof of a vehicle, it increases the height of the vehicle while driving on the road, often resulting in the vehicle being unable to pass due to height restriction on the road. Additionally, an excessive height of the terrace on the roof of the vehicle also affects driving safety. When a vehicle-mounted terrace is installed on a body of a vehicle, the terrace is only confined to a narrow space inside the vehicle, such that further spatial expansion of the terrace in a folding form is impossible in its unfolded plane and height. Moreover, the terrace after being folded in the existing folding structural form occupies a large amount of folding space, reducing the available interior space of the vehicle. Additionally, the installation position of the existing folding terrace is restricted and cannot be adjusted according to an external structure of the vehicle. Thus, there is still a necessary and urgent need to develop and design a vehicle-mounted folding terrace and a vehicle, to solve the problems that an existing terrace mounted on an automobile is confined to a small top space on a roof of the automobile, making lateral space expansion based on a body of the automobile itself impossible, and its folded terrace structure occupies too much space on the top of the automobile, leading to restricted driving of the automobile and impacting driving safety of the vehicle.

### SUMMARY

The present application provides a vehicle-mounted folding terrace, which can solve the problems that an existing terrace mounted on an automobile is confined to a small top space on a roof of the automobile, making lateral space expansion based on a body of the automobile itself impossible, and its folded terrace structure occupies too much space on the top of the automobile, leading to restricted driving of the automobile and impacting driving safety of the vehicle.

The object of the present invention is achieved and its technical problem is solved by the following technical solution.

In a first aspect of the present application, a vehicle-mounted folding terrace is provided, which includes a telescopic sliding mechanism, a folding terrace body structure, and a supporting mechanism, wherein the folding terrace body structure includes a base which is connected to the telescopic sliding mechanism and capable of sliding in the sliding mechanism in a far-end direction and extending out of the sliding mechanism; and the folding terrace body structure is allowed to be folded and unfolded in a sliding direction of the telescopic sliding mechanism and/or in an upward direction of the base. The supporting mechanism is connected to a bottom of a sliding extension end of the folding terrace body structure to support the vehicle-mounted folding terrace and at least partially define an entrance and exit of the vehicle-mounted folding terrace.

Optionally, the telescopic sliding mechanism includes slide rails, side plates, and supporting foot posts; the slide rails are disposed opposite to and parallel with each other, with a limiting plate being provided at one end of each slide rail; outer sides of the slide rails are fixedly connected to the side plates; the height of the side plates is the same as that of the folding terrace body structure after being folded; and the supporting foot posts are disposed on bottom surfaces of end portions of both ends of the slide rails and are connected to the slide rails.

Optionally, a top face of each supporting foot post is connected to the bottom surface of the corresponding slide rail by a bolt; the supporting foot post is rotatable at the bottom surface of the slide rail around a shaft in an axis direction of the bolt; the top face and a bottom surface of the supporting foot post respectively have outer edges extending therefrom; and an outer side surface of the supporting foot post and the outer edge of the top face of the supporting foot post form a snap fit structure.

Optionally, the bottom surface of the supporting foot post is provided with a kidney-shaped elongated slot, which allows the bottom surface of the supporting foot post to be fixed to a vehicle by a bolt.

Optionally, the telescopic sliding mechanism further includes stepping motors which are fixedly disposed at the bottoms of the slide rails, a drive wheel provided on a rotating shaft of each stepping motor, and the drive wheel is provided with a toothed portion; and the bottom of each slide rail is provided with a toothed portion, and the toothed portion of the drive wheel matches the toothed portion on the bottom of the slide rail.

Optionally, the folding terrace body structure includes a foldable bottom plate structure, a top plate structure, and a side plate structure; the foldable bottom plate structure composed of two pieces, one stacked over the other, which are respectively fixedly connected to two ends of hinges that are movably stacked thereon; the top plate structure is located on a top end face of the folding terrace, and includes a front top plate structure and a rear top plate structure, the front top plate structure placed within a front top plate frame provided for the front top plate structure, and the rear top plate structure placed within a rear top plate frame provided for the rear top plate structure; part of the side plate structure is disposed in a front-rear direction along the sliding direction of the telescopic sliding mechanism, and foldably movably connected to the front top plate frame and the rear top plate frame, respectively; and part of the side plate structure is disposed on both sides of the sliding direction of the telescopic sliding mechanism, and fixed within a frame structure formed by the bottom plate structure and the top plate structure as well as the side plate structure.

Optionally, small doors are provided in the side plate structure disposed in the front-rear direction along the sliding direction, and side plate support rods are provided on an edge frame of the side plate structure disposed on each side in the sliding direction.

Optionally, the side plate support rods include a side plate first support rod disposed substantially perpendicular to a sliding surface of the telescopic sliding mechanism and a side plate second support rod disposed in the sliding direction of the telescopic sliding mechanism; the side plate first support rod is disposed between a top frame and a bottom frame of the side plate structure, and is fixedly connected to the top frame and the bottom frame, respectively; and the side plate second support rod is disposed between a side edge frame of the side plate structure and the side plate first support rod, and is fixedly connected to the side edge frame of the side plate structure and the side plate first support rod, respectively.

Optionally, the supporting mechanism includes a climbing ladder disposed along an outer side edge of the folding terrace body structure, and supporting mechanism support rods supported at folded positions on the bottom of the folding terrace body structure; a top end of the climbing ladder is connected to the outer side edge of the folding terrace body structure, and the length of the climbing ladder is adjustable in a length direction of the climbing ladder; the supporting mechanism support rods include a supporting mechanism first support rod and a supporting mechanism second support rod, the supporting mechanism first support rod and the supporting mechanism second support rod respectively disposed at the folded positions on the bottom of the folding terrace body structure that are located on both sides in a sliding direction of the telescopic sliding mechanism.

In a second aspect of the present application, a vehicle is provided, which includes a vehicle body, and the vehicle-mounted folding terrace, wherein the vehicle-mounted folding terrace is mounted on a compartment at the top of the vehicle body or at the tail part of the vehicle body, and is allowed to be folded and/or extended outwards on the compartment at the top of the vehicle body or at the tail part of the vehicle body.

Compared with the prior art, the present application has obvious advantages and beneficial effects. Based on the above technical solution, the present application at least has one of the following advantages and beneficial effects:
I. In the present application, a vehicle-mounted folding terrace is provided, which includes a telescopic sliding mechanism, a folding terrace body structure, and a supporting mechanism, wherein the folding terrace body structure includes a base, which is connected to the telescopic sliding mechanism and capable of sliding in the sliding mechanism in a far-end direction and extending out of the sliding mechanism. The folding terrace body structure is allowed be folded and unfolded in a sliding direction of the telescopic sliding mechanism and/or in an upward direction of the base. The supporting mechanism is connected to the bottom of a sliding extension end of the folding terrace body structure and is configured to support the vehicle-mounted folding terrace and at least partially define an entrance and exit of the vehicle-mounted folding terrace. According to the vehicle-mounted folding terrace provided in the present application, the folding terrace is not confined to a narrow space on a roof of a vehicle, while allowing its installation position to be adjusted according to an external structure of the vehicle, and the folding terrace can be expanded in its unfolded plane and height to obtain a larger accommodating space, and the optimized folding structure enables the folding terrace to occupy less space after being folded.
II. In the present application, a vehicle is provided, which includes a vehicle body, and the vehicle-mounted folding terrace, wherein the vehicle-mounted folding terrace is mounted on a compartment at the top of the vehicle body or at a tail part of the vehicle body, and can be folded and/or extended outwards on the compartment at the top of the vehicle body or at the tail part of the vehicle body. The present application allows the vehicle-mounted folding terrace to be adjusted flexibly according to an external structure of the vehicle such as different installation positions on a compartment at the top of the vehicle body or at a tail part of the vehicle body. When installed on a compartment at the top of the vehicle body, the folding terrace can be expanded in its unfolded plane and height on the compartment at the top of the vehicle body to obtain a larger accommodating space. The folding terrace may also be installed on a compartment at a tail part of the vehicle body and expanded on the compartment at the tail part of the vehicle body. It can be flexibly arranged according to the position of the compartment.

The above description is only a summary of the technical solution of the present application. To understand the technical means of the present application more clearly so as to carry it out in accordance with the content of the specification, and to make the above and other objectives, features and advantages of the present application more apparent and easily understood, preferred embodiments are provided below, along with accompanying drawings, detailed description of which is as follows.

### BRIEF DESCRIPTION OF THE DRAWINGS

FIG. 1 is a schematic structural diagram of a vehicle-mounted folding terrace of embodiments of the present application that is unfolded and opened;

FIG. 2 is a schematic structural diagram of a vehicle-mounted folding terrace of embodiments of the present application that is folded and stowed;

FIGS. 3a and 3b are schematic structural diagrams of a hinge of a vehicle-mounted folding terrace of embodiments of the present application;

FIG. 4 is a schematic structural diagram of folding a vehicle-mounted folding terrace of embodiments of the present application;

FIG. 5 is a schematic structural diagram of a vehicle-mounted unfolding terrace of embodiments of the present application that is unfolded;

FIGS. 6a and 6b are schematic structural diagrams of a supporting foot post of embodiments of the present application; and

FIG. 7 is a schematic structural diagram of a telescopic sliding mechanism of embodiments of the present application.

Description of reference signs

| | |
|---|---|
| 1: telescopic sliding mechanism | 11: slide rail |
| 111: limiting plate | 12: side plate |
| 13: supporting foot post | 131: top face of supporting foot post |
| 132: bottom surface of supporting foot post | 134: first outer edge |
| 135: second outer edge | 136: socket |
| 137: bracket | 138: kidney-shaped elongated slot |
| 14: stepping motor | 141: drive wheel |
| 15: slide rail extension | |
| 2: folding terrace body structure | 21: base |
| 22: bottom plate structure | 221: lower bottom plate |
| 222: upper bottom plate | 223: hinge |
| 2231: hinge lower half | 2231a: first rotating shaft |
| 2232: hinge upper half | 2232a: second rotating shaft |
| 23: top plate structure | 231: top end face |
| 232: front top plate structure | 2321: front top plate frame |
| 2321a: front top plate frame moving direction | 233: rear top plate structure |
| 2331: rear top plate frame | 2331a: rear top plate frame moving direction |
| 24: side plate structure | 241: front side plate structure |
| 241a: front side plate structure moving direction | 242: rear side plate structure |
| 242a: rear side plate structure moving direction | 243: lateral side plate |
| 244: small door | 245: edge frame |
| 246: side plate support rod | 2461: side plate first support rod |
| 2462: side plate second support rod | 247: limiting tie rod |
| 3: supporting mechanism | 31: climbing ladder |
| 32: supporting mechanism support rod | 321: supporting mechanism first support rod |
| 322: supporting mechanism second support rod | |
| 4: entrance and exit | |

### DETAILED DESCRIPTION

To further elaborate on technical means adopted in the present application to accomplish its intended objective, and effects achieved thereby, specific implementations, structures and features of the application provided based on the present application, along with their effects are described in detail below in conjunction with the accompanying drawings and preferred embodiments.

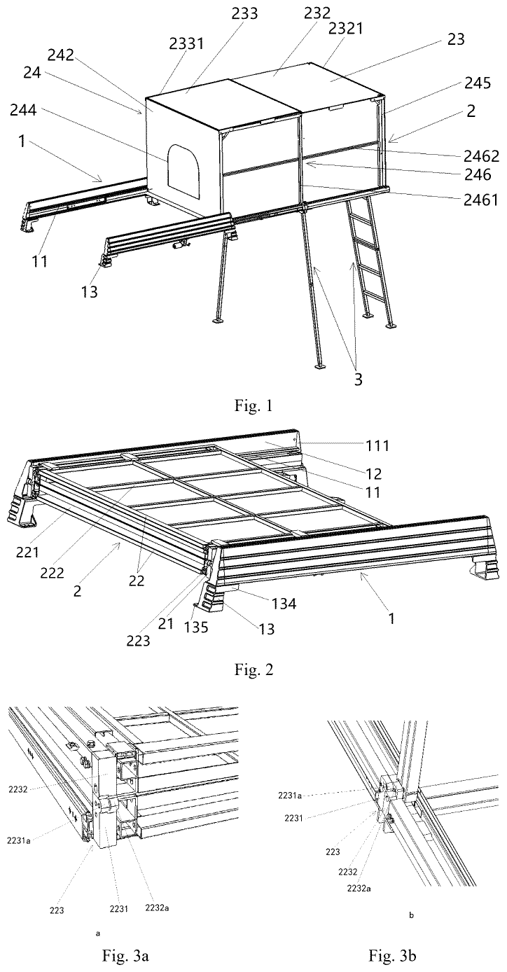

A vehicle-mounted folding terrace is provided in embodiments of the present application, as shown in FIGS. 1 and 2. FIG. 1 is a schematic structural diagram of the vehicle-mounted folding terrace that is unfolded and opened; and FIG. 2 is a schematic structural diagram of the vehicle-mounted folding terrace that is folded and stowed. The vehicle-mounted folding terrace includes a telescopic sliding mechanism 1, a folding terrace body structure 2, and a supporting mechanism 3. The folding terrace body structure 2 includes a base 21. The base 21 is connected to the telescopic sliding mechanism 1 and capable of sliding in the sliding mechanism 1 in a far-end direction and extending out of the sliding mechanism 1. One end of the base 21 can be fixedly connected to the telescopic sliding mechanism 1, and an outward extending end thereof can be movably connected to the telescopic sliding mechanism 1.

In embodiments of the present application, the folding terrace body structure 2 includes a foldable bottom plate structure 22, a top plate structure 23, and a side plate structure 24. The foldable bottom plate structure composed of two pieces, one stacked over the other, includes a lower bottom plate 221 and an upper bottom plate 222. The lower bottom plate 221 and the upper bottom plate 222 are respectively fixedly connected two ends of hinges 223 that are movably stacked thereon. As shown in FIGS. 3a and 3b, each hinge 223 includes a hinge lower half 2231 and a hinge upper half 2232. A first rotating shaft 2231a around a shaft pin is provide on one side of an upper end of the hinge lower half 2231, and a second rotating shaft 2232a around the shaft pin is provided on a side of a lower end of the hinge upper half 2232. The hinge lower half 2231 and hinge upper half 2232 can be folded and stacked, or unfolded and opened to a horizontal state, by means of the first rotating shaft 2231a and the second rotating shaft 2232a, respectively, around the shaft pin.

In embodiments of the present application, the top plate structure 23 is located on a top end face 231 of the folding terrace, and includes a front top plate structure 232 and a rear top plate structure 233. The front top plate structure 232 is placed within a front top plate frame 2321 provided for the front top plate structure 232, and the rear top plate structure 233 is placed within a rear top plate frame 2331 provided for the rear top plate structure 233.

In embodiments of the present application, part of the side plate structure 24 is disposed in a front-rear direction along a sliding direction of the telescopic sliding mechanism 1, and foldably movably connected to the front top plate frame 2321 and the rear top plate frame 2331, respectively; and part of the side plate structure 24 is disposed on both sides of the sliding direction of the telescopic sliding mechanism 1, and fixed within a frame structure formed by the bottom plate structure 22 and the top plate structure 23 as well as the side plate structure 24.

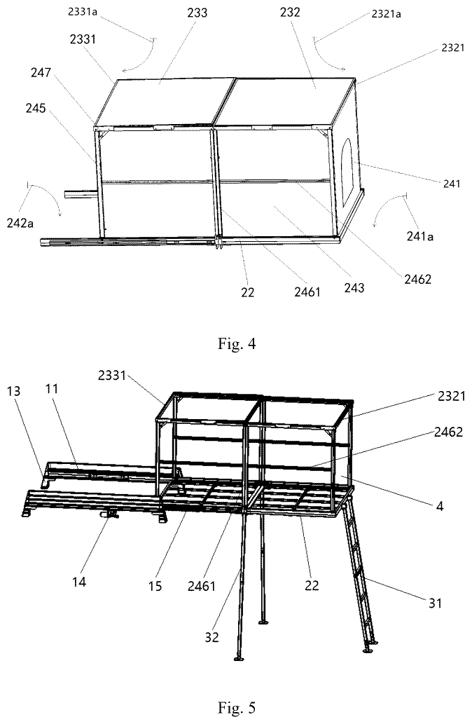

In embodiments of the present application, as in FIG. 4, the side plate structure 24 includes a front side plate structure 241, a rear side plate structure 242, and lateral side plates 243. Small doors 244 are provided in the front side plate structure 241 and the rear side plate structure 242 of the side plate structure 24 disposed in the front-rear direction along the sliding direction, and side plate support rods 246 are provided on an edge frame 245 of the side plate structure 24 disposed on each side in the sliding direction.

In embodiments of the present application, the side plate support rods 246 include a side plate first support rod 2461 disposed substantially perpendicular to a sliding surface of the telescopic sliding mechanism 1 and a side plate second support rod 2462 disposed in the sliding direction of the telescopic sliding mechanism 1. The side plate first support rod 2461 is disposed between a top frame and a bottom frame of the side plate structure 24, and is fixedly connected to the top frame and the bottom frame (or a folding connection portion on the bottom of the bottom plate structure 22), respectively. The side plate second support rod 2462 is disposed between a side edge frame 264 of the side plate structure 24 and the side plate first support rod 2461, and is fixedly connected to the side edge frame 264 of the side plate structure 24 and the side plate first support rod 2461, respectively. The side plate first support rod 2461 is fixed in an up-down direction between the bottom plate structure 22 and top plate structure 23, specifically between a joint part of the front top plate structure 232 and the rear top plate structure 233 and a joint part of the lower bottom plate 221 and the upper bottom plate 222.

In embodiments of the present application, as an optional implementation, in the case where the lateral side plates 243 are four full plates, as shown in FIG. 4, the four full plates are respectively located on two sides of the front side plate structure 241 and the rear side plate structure 242. Upper ends of the lateral side plates 243 are respectively detachably connected to the front top plate frame 2321 and the rear top plate frame 2331 on the top plate structure 23, and lower ends of the lateral side plates 243 are respectively movably connected to the bottom plate structure 22, and can be folded around movable connection portions until the lateral side plates 243 fit against the bottom plate structure 22. The front top plate structure 232 can be moved around a movable connection portion on the front top plate frame 2321 along a front top plate frame moving direction 2321a to a lateral side of the front side plate structure 241 and fit against the front side plate structure 241. At this point, the folded front top plate structure 232 and front side plate structure 241 can be moved together along a front side plate structure moving direction 241a until they fit against a plate surface of the bottom plate structure 22. Among the foldable plates described above, the plate that is folded first has the smallest plate surface area, with its side edge portions being within a space accommodated by frame edge inner walls of the stacked plate in contact therewith. As shown in FIGS. 5, 3a and 3b, further details are omitted here. Similarly, the rear top plate structure 233 can be moved around a movable connection portion on the rear top plate frame 2331 along a rear top plate frame moving direction 2331a to a lateral side of the rear side plate structure 242 and fit against the rear side plate structure 242. At this point, the folded rear top plate structure 233 and rear side plate structure 242 are moved together along a rear side plate structure moving direction 242a until they fit against a plate surface of the bottom plate structure 22. The upper bottom plate 222, and the folded front side plate structure 241 and lateral side plates 243 thereon are folded around the hinges 223 through which the upper bottom plate 222 is movably connected to the lower bottom plate 221, and the upper bottom plate 222, and the folded front side plate structure 241 and lateral side plates 243 thereon are folded to an upper side of the lower bottom plate 221, and the folded rear side plate structure 242 and lateral side plates 243 thereon and fit against the rear side plate structure 242.

In embodiments of the present application, as another optional implementation, in the case where the lateral side plates 243 are eight full plates, as shown in FIGS. 4 and 5, four full plates are respectively located on each side of the front side plate structure 241 and the rear side plate structure 242. Upper ends of the lateral side plates 243 located at an upper side are respectively detachably connected to the front top plate frame 2321 and the rear top plate frame 2331 on the top plate structure 23; and lower ends of the lateral side plates 243 located at the upper side are respectively connected to upper ends of the lateral side plates 243 located at a lower side by means of a foldable hinge. Lower ends of the lateral side plates 243 located at a lower side are respectively movably connected to the bottom plate structure 22, such that when the lateral side plates 243 located at the upper side and the lateral side plates 243 located at the lower side are folded together towards the interior of the vehicle-mounted folding terrace around the foldable hinge, the lateral side plates 243 located at the upper side and the lateral side plates 243 located at the lower side are folded onto the bottom plate structure 22. The front top plate structure 232, the front side plate structure 241, the rear top plate structure 233, and the rear side plate structure 242 are also folded according to the above-described folding methods and steps, such that the front top plate structure 232, the front side plate structure 241, the rear top plate structure 233, and the rear side plate structure 242, as well as the lateral side plates 243 are folded between the folded lower bottom plate 221 and upper bottom plate 222 (as shown in FIG. 2).

In embodiments of the present application, as another optional implementation, in the case where the lateral side plates 243 include eight full plates, as shown in FIGS. 4 and 5, four full plates are respectively located within frames formed on each side of the front side plate structure 241 and the rear side plate structure 242. The lateral side plates 243 may be disposed within frames formed by the side plate first support rod 2461 and the side plate second support rod 2462. The frames formed by the side plate first support rod 2461 and the side plate second support rod 2462 are freely detachable at connection portions on the edge frame 245, the front top plate frame 2321, and the rear top plate frame 2331. When folding the lateral side plates 243, the lateral side plates 243 are detached along the frames, and stacked on the bottom plate structure 22, after which the bottom plate structure 22 is folded around the hinges 223 to form a folded vehicle-mounted folding terrace (as shown in FIG. 2). Limiting tie rods 247 are provided at movable connection portions on the front top plate structure 232 and the rear side plate structure 242. When the front top plate structure 232 and the rear side plate structure 242 are caused to open, the limiting tie rods 247 restrict opening unfolding angles thereof, as shown in FIGS. 2, 4 and 5, so that the front top plate structure 232 and the rear top plate structure 233 are respectively located in the same plane after being unfolded. The limiting tie rods 247 enables the structure formed by the fully unfolded vehicle-mounted folding terrace to be more stable. In embodiments of the present application, reverse operations can be carried out for the unfolding method of the vehicle-mounted folding terrace and the various folding methods described above, and all these can be implemented. Further details are omitted here.

In embodiments of the present application, the telescopic sliding mechanism 1 includes slide rails 11, side plates 12, and supporting foot posts 13. The slide rails 11 are disposed opposite to and parallel with each other, with a limiting plate 111 being provided at one end of each slide rail 11. Outer sides of the slide rails 11 are fixedly connected to the side plates 12. The height of the side plates 12 is the same as that of the folding terrace body structure 2 after being folded, and the height does not exceed the length of the lower bottom plate 221 or the length of the upper bottom plate 222. The supporting foot posts 13 are disposed on bottom surfaces of end portions of both ends of the slide rails 11 and are connected to the slide rails 11.

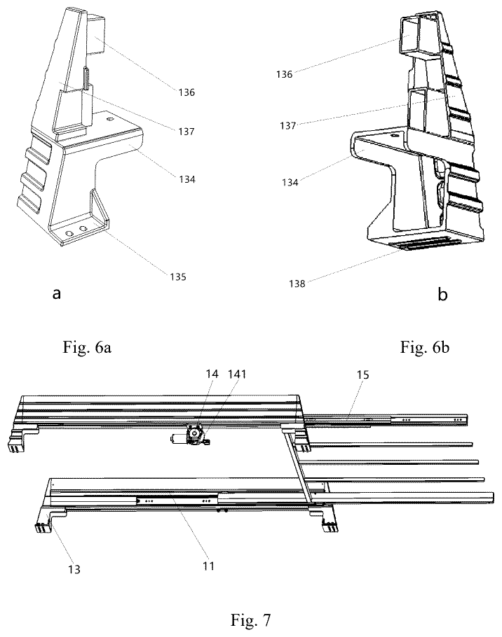

In embodiments of the present application, as in FIG. 6a, a top face of each supporting foot post 13 is connected to the bottom surface of the corresponding slide rail 11 by a bolt, as in FIG. 6b. The supporting foot post 13 is rotatable at the bottom surface of the slide rail 11 around a shaft in an axis direction of the bolt. The top face of the supporting foot post 131 and a bottom face of the supporting foot post 132 respectively have a first outer edge 134 and a second outer edge 135 extending therefrom. An outer side surface of the supporting foot post 13 and the first outer edge 134 of the top face of the supporting foot post form a snap fit structure. The second outer edge 135 may also be provided with a reinforcing rib or a stabilizing plate for supporting and securing the supporting foot post 13. The supporting foot post 13 may also be provided with a bracket 137. A socket 136 for connection to an end face of the slide rail 11 is arranged oppositely to a sidewall of the bracket 137. The supporting foot post is fixed to the end face of the slide rail 11 by means of the socket 136 of the bracket 137. The supporting foot post 13 shown is of a hollow structure, which saves material, reduces manufacturing costs, decreases the weight of the vehicle-mounted folding terrace, and facilitates handling and arrangement.

In embodiments of the present application, as an optional implementation, the bottom surface of the supporting foot post 13 is provided with a kidney-shaped elongated slot 138, which allows the bottom surface of the supporting foot post 13 to be fixed to a vehicle by a bolt, or fixed to a vehicle by means of a bolt hole provided in the second outer edge 135 in conjunction with a bolt and a nut. When being fixed to the vehicle, the bottom surface of the supporting foot post can be conveniently positioned at a suitable fixing location by adjusting the position of the bolt and nut on the kidney-shaped elongated slot 138.

In embodiments of the present application, as shown in FIG. 7, the telescopic sliding mechanism 1 further includes stepping motors 14, which are fixedly disposed at the bottoms of the slide rails 11. A drive wheel 141 is provided on a rotating shaft of each stepping motor 14, and the drive wheel 141 is provided with a toothed portion. Each slide rail 11 further includes a slide rail extension 15. The slide rail extension 15 is located at the bottom of the slide rail 11 and is movably connected to the slide rail 11. The slide rail extension 15 movably connected at the bottom of the slide rail 11 is provided with a toothed portion, and the toothed portion of the drive wheel matches the toothed portion on the bottom of the slide rail. The stepping motor 14 drives the slide rail extension 15 at the bottom of the slide rail 11 by means of the drive wheel 141, causing the folding terrace body structure 2 disposed on the slide rail 11 to extend outwards. After the folding terrace body structure 2 is folded and stowed, the slide rail extension 15 at the bottom of the slide rail 11 is driven in a reverse direction by the drive wheel 141 of the stepping motor 14, causing the folding terrace body structure 2 disposed on the slide rail 11 to move in a stowed direction. As an optional implementation, the stepping motor 14 can drive the slide rail extension portion 15 to adjust the position of the above-described vehicle-mounted folding terrace during opening or folding, and once the position is adjusted appropriately, the stepping motor 14 is turned off to stop driving.

In embodiments of the present application, as shown in FIGS. 1 to 7, the folding terrace body structure 2 can be folded and unfolded in a sliding direction of the telescopic sliding mechanism 1 and/or in an upward direction of the base 21.

In embodiments of the present application, as shown in FIGS. 1 and 5, the supporting mechanism 3 includes a climbing ladder 31 disposed along an outer side edge of the folding terrace body structure 1, and supporting mechanism support rods 32 supported at folded positions on the bottom of the folding terrace body structure 1. A top end of the climbing ladder 31 is connected to the outer edge of the folding terrace body structure 2. The climbing ladder 31 may be formed by a plurality of climbing ladder segments connected successively, and the length of the climbing ladder 31 is adjustable in a length direction of the climbing ladder 31. The length of the climbing ladder 31 is adjusted to adjust the inclination of the climbing ladder 31 connected to the folding terrace body structure 2. Alternatively, by adjusting the length of the climbing ladder 31 described above, it may also be arranged on sloped ground. The supporting mechanism support rods 32 include a supporting mechanism first support rod 321 and a supporting mechanism second support rod 322. The supporting mechanism first support rod 321 and the supporting mechanism second support rod 322 are respectively disposed in recess structures at the folded positions on the bottom of the folding terrace body structure 2 provided on both sides in the sliding direction of the telescopic sliding mechanism 1.

In embodiments of the present application, each of the above-described supporting mechanism support rods 32 may further include a long straight rod composed of a plurality of support rod segments inserted (or spliced) into one another successively. In order to resist ground subsidence under force, support pads may further be provided at the bottoms of the supporting mechanism support rods 32, respectively. The bottom areas of the support pads are larger than the diameters of the supporting mechanism support rods 32. The supporting mechanism support rod 32 are movably connected to the centers of the support pads. An angle between each supporting mechanism support rod 32 and the corresponding support pad can be further adjusted based on adjustments of length and inclination of the supporting mechanism support rod 32.

In embodiments of the present application, the supporting mechanism 3 is connected to the bottom of the sliding extension end of the folding terrace body structure 2, for supporting the vehicle-mounted folding terrace, and the support of the folding terrace body structure 2 by the supporting mechanism support rods 32 and the climbing ladder 31 is further enhanced by the above-described support pads and length adjustment structure. Moreover, the climbing ladder 31 is disposed on a side of an outward extending small door 244. The climbing ladder 31 serves as a means for a user to climb. In addition, the climbing ladder 31 is provided such that the climbing ladder 31 supports the vehicle-mounted folding terrace, and at least partially defines an entrance and exit 4 of the vehicle-mounted folding terrace on the side of the outward extending small door 244.

In embodiments of the present application, a vehicle (not shown in the drawings) is also provided in the present application. The vehicle includes a vehicle body and the vehicle-mounted folding terrace. The vehicle-mounted folding terrace is mounted on a compartment at the top of the vehicle body or at a tail part of the vehicle body, and can be folded and/or extended outwards on the compartment at the top of the vehicle body or at the tail part of the vehicle body. For the above-described folding and/or outward extending of the vehicle-mounted folding terrace on the compartment at the top of the vehicle body or at the tail part of the vehicle body, see the above description of the folding and unfolding of the vehicle-mounted folding terrace and the outward extending of the telescopic sliding mechanism 1, which will not be repeated here.

The above description only involves preferred embodiments of the present application, and does not limit the present application in any form. Although the present application has been disclosed above with the preferred embodiments, the present application is not limited thereto. Any persons skilled in the art can use the disclosed technical contents described above to make some alterations or modifications to produce equivalent embodiments with equivalent variations without departing from the technical solution of the present application. All simple modifications, equivalent variations, and modifications made to the above embodiments according to the technical essence of the present application without departing from the technical solution of the present application still fall within the scope of the technical solution of the present application.

1. A vehicle-mounted folding terrace, comprising a telescopic sliding mechanism, a folding terrace body structure, and a supporting mechanism, wherein:
the folding terrace body structure comprises a base connected to the telescopic sliding mechanism and capable of sliding in the sliding mechanism in a far-end direction and extending out of the sliding mechanism;
the folding terrace body structure is operable to be folded and unfolded in a sliding direction of the telescopic sliding mechanism and/or in an upward direction of the base; and
the supporting mechanism is connected to a bottom of a sliding extension end of the folding terrace body structure to support the vehicle-mounted folding terrace and at least partially define an entrance and exit of the vehicle-mounted folding terrace.

2. The vehicle-mounted folding terrace according to claim 1, wherein:
the telescopic sliding mechanism comprises slide rails, side plates, and supporting foot posts;
the slide rails are disposed opposite to and parallel with each other, with a limiting plate being provided at one end of each slide rail;
outer sides of the slide rails are fixedly connected to the side plates, the height of the side plates equal to that of the folding terrace body structure after folded; and
the supporting foot posts are disposed on bottom surfaces of end portions of both ends of the slide rails and are connected to the slide rails.

3. The vehicle-mounted folding terrace according to claim 2, wherein:
a top face of each supporting foot post is connected to the bottom surface of the corresponding slide rail by a bolt;
the supporting foot post is rotatable at the bottom surface of the slide rail around a shaft in an axis direction of the bolt;
the top face and a bottom surface of the supporting foot post respectively have outer edges extending therefrom; and
an outer side surface of the supporting foot post and the outer edge of the top face of the supporting foot post form a snap fit structure.

4. The vehicle-mounted folding terrace according to claim 3, wherein the bottom surface of the supporting foot post is provided with a kidney-shaped elongated slot, allowing the bottom surface of the supporting foot post to be fixed to a vehicle by a bolt.

5. The vehicle-mounted folding terrace according to claim 2, wherein:
the telescopic sliding mechanism further includes stepping motors which are fixedly disposed at the bottoms of the slide rails, a drive wheel provided on a rotating shaft of each stepping motor, and the drive wheel provided with a toothed portion; and
the bottom of each slide rail is provided with a toothed portion, and the toothed portion of the drive wheel matches the toothed portion on the bottom of the slide rail.

6. The vehicle-mounted folding terrace according to claim 1, wherein:
the folding terrace body structure comprises a foldable bottom plate structure, a top plate structure, and a side plate structure;
the foldable bottom plate structure comprises two pieces, one stacked over the other and respectively fixedly connected to two ends of hinges that are movably stacked thereon;
the top plate structure is located on a top end face of the folding terrace, and comprises a front top plate structure and a rear top plate structure, the front top plate structure placed within a front top plate frame provided for the front top plate structure, and the rear top plate structure placed within a rear top plate frame provided for the rear top plate structure;
a part of the side plate structure is disposed in a front-rear direction along the sliding direction of the telescopic sliding mechanism and is foldably and movably connected to the front top plate frame and the rear top plate frame, respectively; and
a part of the side plate structure is disposed on both sides of the sliding direction of the telescopic sliding mechanism, and fixed within a frame structure formed by the bottom plate structure, the top plate structure, and the side plate structure.

7. The vehicle-mounted folding terrace according to claim 6, wherein:
doors are provided in the side plate structure disposed in the front-rear direction along the sliding direction, and
side plate support rods are provided on an edge frame of the side plate structure disposed on each side in the sliding direction.

8. The vehicle-mounted folding terrace according to claim 7, wherein:
the side plate support rods comprise a side plate first support rod disposed substantially perpendicular to a sliding surface of the telescopic sliding mechanism and a side plate second support rod disposed in the sliding direction of the telescopic sliding mechanism;
the side plate first support rod is disposed between a top frame and a bottom frame of the side plate structure, and is fixedly connected to the top frame and the bottom frame, respectively; and
the side plate second support rod is disposed between a side edge frame of the side plate structure and the side plate first support rod, and is fixedly connected to the side edge frame of the side plate structure and the side plate first support rod, respectively.

9. The vehicle-mounted folding terrace according to claim 1, wherein:
the supporting mechanism comprises a climbing ladder disposed along an outer side edge of the folding terrace body structure, and supporting mechanism support rods supported at folded positions on the bottom of the folding terrace body structure;
a top end of the climbing ladder is connected to the outer side edge of the folding terrace body structure, and the length of the climbing ladder is adjustable in a length direction of the climbing ladder; and
the supporting mechanism support rods comprise a supporting mechanism first support rod and a supporting mechanism second support rod, the supporting mechanism first support rod and the supporting mechanism second support rod respectively disposed at the folded positions on the bottom of the folding terrace body structure that are located on both sides in a sliding direction of the telescopic sliding mechanism.

10. A vehicle comprising a vehicle body, and the vehicle-mounted folding terrace of claim 1, wherein the vehicle-mounted folding terrace is mounted on a compartment at the top of the vehicle body or at the tail part of the vehicle body, and is configured to be folded and/or extended outwards on the compartment at the top of the vehicle body or at the tail part of the vehicle body.
